(19) United States
(12) Patent Application Publication
(10) Pub. No.: US 2025/0183985 A1
(43) Pub. Date: Jun. 5, 2025

(54) SYSTEM AND APPARATUS SUITABLE FOR COMMUNICATION IN ASSOCIATION WITH QUASI-COLOCATION AND A COMMUNICATION METHOD IN ASSOCIATION THERETO

(71) Applicant: Continental Automotive Technologies GmbH, Hannover (DE)

(72) Inventors: Reuben George Stephen, Singapore (SG); David Gonzalez Gonzalez, Egelsbach (DE); Rikin Shah, Langen (DE); Osvaldo Gonsa, Frankfurt (DE); Andreas Andrae, Frankfurt am Main (DE)

(73) Assignee: Continental Automotive Technologies GmbH, Hannover (DE)

(21) Appl. No.: 18/842,056

(22) PCT Filed: Feb. 27, 2023
(86) PCT No.: PCT/EP2023/054821

§ 371 Date: Aug. 28, 2024

(30) Foreign Application Priority Data
Feb. 28, 2022 (DE) 10 2022 202 050.2

(51) Int. Cl. H04B 7/06; H04W 8/00; H04W 92/18

(52) U.S. Cl. CPC H04B 7/06968; H04W 8/005; H04W 92/18

(57) ABSTRACT

Communication between an apparatus and at least one user equipment is facilitated. Quasi-Colocation (QCL) relationship between the apparatus and the UE can be determined in a discovery step. The QCL relationship can be determined by manner of, for example, a QCL-discovery message. The QCL-discovery message can be communicated between the apparatus and the UE. Communication between the apparatus and the UE can be based on direct (e.g., sidelink) communication.

### CROSS-REFERENCE TO RELATED APPLICATIONS

The present application is a National Stage Application under 35 U.S.C. § 371 of International Patent Application No. PCT/EP2023/054821 filed on Feb. 27, 2023, and claims priority from German Patent Application No. 10 2022 202 050.2 filed on Feb. 28, 2022, in the German Patent and Trademark Office, the disclosures of which are herein incorporated by reference in their entireties.

### FIELD OF INVENTION

The present disclosure generally relates to one or both of a system and an apparatus suitable for communication (e.g., direct communication such as Sidelink-based communication) in association with, for example, User Equipment (UE) Quasi-Colocation. The present disclosure further relates a communication method which can be associated with the system and/or the apparatus.

### BACKGROUND

Generally, the 3rd Generation Partnership Project (3GPP) had introduced the concept of Quasi-Colocation (QCL) for a transmitter (typically a next generation node B (gNB)) to provide indication to a receiver (typically a user equipment) and/or to assist in procedures such as channel estimation, beam management, frequency offset error estimation, and synchronization for user equipment (UE).

QCL, in the context of the abovementioned procedures can possibly facilitate reduction in complexity, and improvement in terms of reliability and energy consumption.

The present disclosure contemplates the possibility that there could be one or more other applications (i.e., use) of the QCL not contemplated by current state of the art.

### BRIEF SUMMARY

In accordance with an aspect of the disclosure, there is provided an apparatus which can, for example, be suitable for facilitating communication in relation to, for example, a vehicle. For example, the apparatus can be suitable for use in association with a vehicle, in accordance with an embodiment of the disclosure. The apparatus can, for example, be referred to as an in-vehicle apparatus.

Specifically, the present disclosure contemplates, in one aspect, an apparatus which can be suitable for use for communication (e.g., direct communication such as sidelink-based communication) in association with user equipment (UE) (e.g., one or more UE in a vehicle and/or one or more UE outside a vehicle) which can, for example, be proximal, in location, to the apparatus, in accordance with an embodiment of the disclosure. Specifically, the apparatus can be suitable for use for, for example, sidelink communication in association with proximal UE (e.g., one or more UE in the proximity of the apparatus).

The apparatus and the UE can, for example, be carried by/in a vehicle (e.g., both the in-vehicle apparatus and the vehicle UE can be carried by the same vehicle), in accordance with an embodiment of the disclosure.

The apparatus can, for example, include a processor and a transmitter, in accordance with an embodiment of the disclosure. The processor can be coupled to the transmitter.

The processor can be configured to generate a Quasi Colocation (QCL)-discovery message and the transmitter can be configured to communicate the QCL-discovery message. For example, the transmitter can be configured to communicate the QCL-discovery message in a manner such that the QCL-discovery message can be received by the UE. Moreover, the apparatus and the UE can be capable of communicating (e.g., with each other) based on sidelink communication. It is contemplated that the QCL relationship between the apparatus and the UE can be determined based on the QCL-discovery message.

In one embodiment, the processor can be configured to generate the QCL-discovery message based on a Proximity Services (ProSe) framework using vehicle QCL-specific information. Moreover, the QCL-discovery message can, for example, be associated with a sub-procedure of QCL-determination, in accordance with an embodiment of the disclosure. It is contemplated that QCL-determination can, for example, be based on dedicated sidelink resources indicated by a node initiating sidelink communication using either system information or Medium access control (MAC)-level signaling, in accordance with an embodiment of the disclosure. It is contemplated that the system information can be capable of being broadcasted on demand, in accordance with an embodiment of the disclosure. Additionally, in one embodiment, QCL determination can, for example, be via Medium Access Control (MAC) Control Elements (CE). The MAC CE can be associated with a plurality of parameters (RS), wherein usage of an RS is indicated through bit map by manner of using at least one octet, and wherein “1” indicates that an RS is being used and “0” indicates that an RS is not being used. For example, the MAC CE format can, for example, be indicated by “00100000”.

It is appreciable that in the above manner, QCL (e.g., in-vehicle QCL) can possibly be facilitated, in accordance with an embodiment of the disclosure. As mentioned earlier, in-vehicle QCL can relate to an established/determined QCL relationship between the UE (e.g., the in-vehicle apparatus 102 and the vehicle UE) carried by, for example, the vehicle.

Moreover, it is appreciable that communication (e.g., direct communication such as sidelink communication) between within a vehicle and outside of the vehicle can possibly be facilitated by manner of QCL-notification (e.g., a QCL-notification message which can be communication by manner of, for example, broadcast, unicast and/or groupcast), in accordance with an embodiment of the disclosure. In this regard, for example, sidelink communication between a vehicle and another vehicle, and/or, for example, sidelink communication between a vehicle and a pedestrian etc. can be facilitated.

Additionally, it is appreciable that, sidelink channel estimation and/or transmission diversity can possibly be facilitated, in accordance with an embodiment of the disclosure.

The present disclosure further contemplates that synchronization can possibly be simplified and/or facilitated in a more efficient manner, in accordance with an embodiment of the disclosure.

The above-described advantageous aspect(s) of the apparatus (e.g., referrable to as “in-vehicle apparatus” in accordance with an embodiment of the disclosure) of the present disclosure can also apply analogously (all) the aspect(s) of a below described communication method of the present disclosure. Likewise, all below described advantageous aspect(s) of the communication method of the disclosure can also apply analogously (all) the aspect(s) of above described apparatus of the disclosure.

In accordance with an aspect of the disclosure, there is provided a communication method which can be suitable for use for communication (e.g., direct communication such as sidelink communication) between an apparatus and a user equipment (UE). The communication method can include a discovery step wherein Quasi-Colocation (QCL) relationship between the apparatus and the UE can be determined. It is contemplated that the QCL relationship can be determined by manner of, for example, a QCL-discovery message. The QCL-discovery message can, for example, be communicated between the apparatus and the UE, in accordance with an embodiment of the disclosure. In one embodiment, communication between the apparatus and the UE can be based on sidelink communication.

The data communication method can further include at least one of (i.e., any one of or any combination of the following):
a determination step wherein a processing task of QCL-determination is performed. The QCL-determination can, for example, be a sub-procedure associated with QCL-discovery.
a notification step wherein a QCL-notification message can be generated. The QCL-notification message can, for example, be communicated from the apparatus, in accordance with an embodiment of the disclosure.
an output step wherein at least one output signal can be communicated from, for example, the apparatus. The output signal(s) can, for example, include one or both of the QCL-discovery message and the QCL-notification message (i.e., at least one of the QCL-discovery message and the QCL-notification message; the QCL-discovery message and/or the QCL-notification message), in accordance with an embodiment of the disclosure.

It is appreciable that in the above manner, that QCL (e.g., in-vehicle QCL) can possibly be facilitated, in accordance with an embodiment of the disclosure. As mentioned earlier, in-vehicle QCL can relate to an established/determined QCL relationship between the UE (e.g., the in-vehicle apparatus 102 and the vehicle UE) carried by, for example, the vehicle.

Moreover, it is appreciable that communication (e.g., direct communication such as sidelink communication) between within a vehicle and outside of the vehicle can possibly be facilitated by manner of QCL-notification (e.g., a QCL-notification message), in accordance with an embodiment of the disclosure. In this regard, for example, sidelink communication between a vehicle and another vehicle, and/or, for example, sidelink communication between a vehicle and a pedestrian etc. can be facilitated.

Additionally, it is appreciable that, sidelink channel estimation and/or transmission diversity can possibly be facilitated, in accordance with an embodiment of the disclosure.

The present disclosure further contemplates that synchronization can possibly be simplified and/or facilitated in a more efficient manner, in accordance with an embodiment of the disclosure.

The present disclosure further contemplates, in association with the abovementioned communication method, a computer program which can include instructions which, when the program is executed by a computer, cause the computer to carry out any one of the discovery step, the determination step, the notification step and the output step, or any combination thereof.

The present disclosure yet further contemplates, in association with the abovementioned communication method, a computer readable storage medium (not shown) having data stored therein representing software executable by a computer (not shown), the software including instructions, when executed by the computer, to carry out any one of the discovery step, the determination step, the notification step and the output step, or any combination thereof.

### BRIEF DESCRIPTION OF THE DRAWINGS

Embodiments of the disclosure are described hereinafter with reference to the following drawings.

FIG. 1a shows a system which can include at least one apparatus, according to an embodiment of the disclosure.

FIG. 1b shows an example Medium access control (MAC) Control Element (CE) format usable in association with the system of FIG. 1a, according to an embodiment of the disclosure.

FIG. 2 shows the apparatus of FIG. 1a in further detail, according to an embodiment of the disclosure.

FIG. 3 shows a communication method in association with the system of FIG. 1a, according to an embodiment of the disclosure.

### DETAILED DESCRIPTION

The present disclosure contemplates that the 3GPP's conventional Quasi-Colocation (QCL) is typically defined for different antenna ports of a Next Generation Node B (gNB) for downlink communication from a gNB to one or more UEs. Different user equipment (UE) involved in communication and sharing QCL properties may not be capable of (fully) realizing potential benefit(s) based on the current framework.

The present disclosure contemplates the possibility there could be one or more other applications (i.e., uses), not contemplated by current state of the art, which could potentially leverage the benefit(s) of Quasi-Colocation (QCL).

The present disclosure contemplates that one such possible application can be in association with different user equipment (UE) carried by, for example, a vehicle in connection with/in the context of communication (e.g., direct communication) such as Sidelink-based communication. It is contemplated that Sidelink based communication (i.e., hereinafter “sidelink communication”) can include one or both of transmission and reception (i.e., transmitting and/or receiving). In this regard, the present disclosure generalizes the notion of QCL to essentially any combination of transmission and reception, in accordance with an embodiment of the disclosure. Specifically, the present disclosure contemplates direct communication such as sidelink communication, in accordance with an embodiment of the disclosure.

Moreover, UE carried by a vehicle can, for example, be referred to as “in-vehicle UE”, in accordance with an embodiment of the disclosure.

Concerning the application of QCL in association with in-vehicle UE, it is generally contemplated that a plurality of UE (e.g., in-vehicle UE and/or UE outside of the vehicle) participating in communication (e.g., direct communication such as sidelink communication) can be established, and the UE participating in, for example, sidelink communication can be notified about the QCL relationship, in accordance with an embodiment of the disclosure.

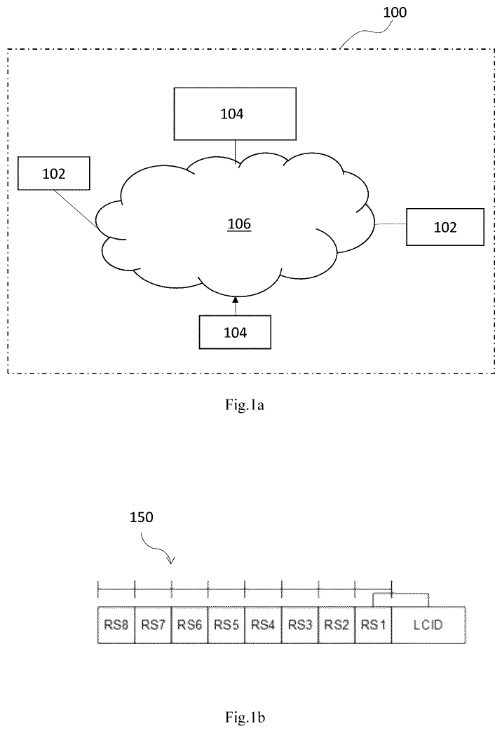

The foregoing will be discussed in further detail with reference to FIG. 1 to FIG. 3 hereinafter.

Referring to FIG. 1a, a system 100 is shown, according to an embodiment of the disclosure. As shown, the system 100 can include one or more apparatuses 102, at least one device 104 and, optionally, a communication network 106, in accordance with an embodiment of the disclosure.

The apparatus(es) 102 can be coupled to the device(s) 104. Specifically, the apparatus(es) 102 can, for example, be coupled to the device(s) 104 via the communication network 106.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

The system 100 can, for example, be suitable for facilitating communication (e.g., direct communication) such as sidelink-based communication (i.e., referrable to as “sidelink communication”) in association with, for example, Quasi-Colocation (QCL), in accordance with an embodiment of the disclosure.

For example, the system 100 can be suitable for sidelink communication in association with a plurality of UE (not shown), in accordance with an embodiment of the disclosure. In a specific example, the system 100 can be suitable for sidelink communication in association with in-vehicle UE, in accordance with an embodiment of the disclosure.

The system 100 will now be discussed based on an example context of sidelink communication in association with in-vehicle UE, in accordance with an embodiment of the disclosure, hereinafter.

As mentioned earlier, the system 100 can include one or more apparatuses 102, at least one device 104 and, optionally, a communication network 106, in accordance with an embodiment of the disclosure.

In the example context, the system 100 can include a first apparatus 102 which can be carried by a vehicle (e.g., mounted/installed in the vehicle) and a second apparatus 102 which can be carried in the vehicle (e.g., a mobile device carried into the vehicle by a user of the vehicle). In this regard, the (same) vehicle can be considered to carry a plurality of UE (e.g., the first and second apparatuses 102). The UE carried by the vehicle (i.e., the first and second apparatuses 102) can be referred to as in-vehicle UE. In one embodiment, the first apparatus 102 can communicate with the second apparatus 102. The first apparatus 102 can, in a specific example, be coupled to the second apparatus 102 via the communication network 106, in accordance with an embodiment of the disclosure.

The system 100 can further include a third apparatus 102 carried by another vehicle (a different vehicle from the vehicle carrying the first and second apparatuses 102) and the third apparatus 102 can be capable of communicating (e.g., via the communication network 106) with one or both of the first and second apparatuses 102 (i.e., the first apparatus 102 and/or the second apparatus 102), in accordance with an embodiment of the disclosure. For example, the third apparatus 102 can be coupled to the first apparatus 102 and/or the second apparatus 102. In a specific example, the third apparatus 102 can be coupled to the first apparatus 102 and/or the second apparatus 102 via the communication network 106.

The system 100 can further include a device 104 which can be carried by, for example, a pedestrian (i.e., the device 104 is not carried in/by a vehicle). The device 104 can, for example, communicate with any one of the first, second and third apparatuses 102, or any combination thereof (i.e., the first apparatus 102, the second apparatus 102 and/or the third apparatus 102), in accordance with an embodiment of the disclosure. In a specific example, the device 104 can be coupled to the first apparatus 102, the second apparatus 102 and/or the third apparatus 102 via the communication network 106.

In this regard, it is appreciable that the first and second apparatuses 102 can, for example, be considered to be in-vehicle UE carried by a vehicle (e.g., a first vehicle which is not shown), in accordance with an embodiment of the disclosure (i.e., the first and second apparatus(es) 102 can be considered to be in-vehicle UE with respect to the first vehicle). The third apparatus 102 can, for example, be considered to be in-vehicle UE carried by another vehicle (e.g., a second vehicle which is not shown), in accordance with an embodiment of the disclosure (i.e., the third apparatus 102 can be considered to be in-vehicle UE with respect to the second vehicle). The device(s) 104 can, for example, be considered to be UE outside of a vehicle (e.g., outside of the first and second vehicles), in accordance with an embodiment of the disclosure. Moreover, the third apparatus 102 can be considered to be UE outside of the first vehicle whereas the first and second apparatus(es) 102 can be considered to be UE outside of the second vehicle, in accordance with an embodiment of the disclosure.

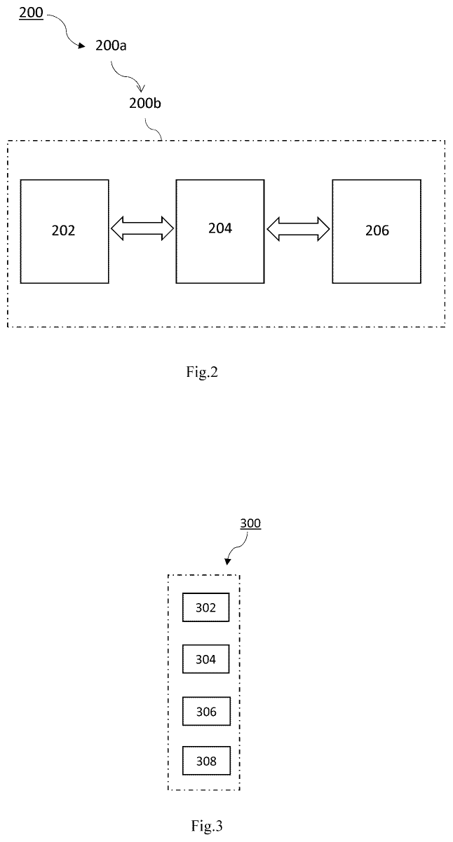

The apparatus(es) 102 can, for example, correspond to one or more computers (e.g., an electronic device/module having computing capabilities such as an electronic mobile device which can be carried into a vehicle or an electronic module which can be installed in a vehicle, in accordance with an embodiment of the disclosure. The apparatus(es) 102 can, in one embodiment, include one or more processors (not shown) which can be configured to perform one or more processing tasks. Generally, the processing task(s), in connection with the apparatus(es) 102, can, for example, include one or both of discovery-related processing (e.g., QCL-discovery) and determination-related processing (e.g., QCL determination), in accordance with an embodiment of the disclosure. The processing task(s), in connection with the apparatus(es) 102, can, for example, further include notification-related processing (e.g., QCL notification), in accordance with an embodiment of the disclosure. The apparatus(es) 102 will be discussed later in further detail with reference to FIG. 2, according to an embodiment of the disclosure.

The device(s) 104 can be configured to receive data communicated from the apparatus(es) 102 and perform one or more processing tasks. Processing task(s), in connection with the device(s) 104, can, for example, include output-based processing (e.g., for visual and/or audio consumption of received data by the pedestrian carrying the device 104)), in accordance with an embodiment of the disclosure.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

Earlier mentioned, concerning the application of QCL in association with in-vehicle UE, it is generally contemplated that a plurality of UE (e.g., which can include one or both of in-vehicle UE and UE outside of a vehicle) participating in sidelink communication can be established, and the UE participating in sidelink communication can be notified about the QCL relationship, in accordance with an embodiment of the disclosure.

In this regard, it is contemplated that the QCL relationship, as between the plurality of UE would need to be determined/established. For example, it is contemplated that the QCL relationship between the in-vehicle UE (e.g., between the first and second apparatuses 102) would need to be determined/established.

The present disclosure contemplates the issue of establishing/determining QCL relationship based on an example scenario hereinafter.

Specifically, the above example context will now be discussed in further detail based on an example scenario, in accordance with an embodiment of the disclosure, hereinafter.

In the example scenario, it is contemplated that QCL relationship can possibly be established/determined by manner of one or both of QCL-discovery and QCL-determination (i.e., QCL-discovery and/or QCL-determination).

QCL-discovery can be by manner of utilizing a QCL-discovery message. The QCL-discovery message can, for example, be a dedicated QCL-discovery message. For example, Proximity Services (ProSe)/sidelink among the in-vehicle UE (e.g., among the first and second apparatuses 102) can be utilized. It is contemplated that information data can be inserted in such a QCL-discovery message. The information data that can be inserted can include one or more parameters that can be considered to be relevant. Such relevant parameter(s) can, for example, include reference signal (RS) associated with a gNB (Next Generation Node B). The RS can include/be associated with/indicative of one or both of port number and resources, and can be used to validate QCL. An SSB port can be an example. In this regard, it is appreciable that QCL-discovery can generally be based on the utilization of existing ProSe framework with vehicle QCL-specific information (e.g., service/app ID etc.).

QCL-determination (e.g., which can be a sub-procedure of the QCL-discovery, in one embodiment) can be based on dedicated sidelink resources (e.g., sidelink in-vehicle QCL RS) and resources can be indicated by the node initiating sidelink communication using system information (static) or Medium access control (MAC)-level signaling (dynamic). Moreover, for QCL determination, system information can be broadcasted on-demand. In one example, for QCL determination via MAC CE (Control elements), an example MAC CE format 150, as shown in FIG. 1b, can be used to indicate the RS to be used, in accordance with an embodiment of the disclosure.

As shown, the MAC CE format can include a plurality of parameters/components (e.g., denoted by “RS1” to “RS8”). It can be appreciated that a parameter/component “RS” can be indicated through a bit map by using one or more octet whereby “1” can indicate that a “RS” parameter is being used (e.g., “RS6”) and “0” can indicate that a “RS” is not being used (e.g., “RS8,” “RS7” and “RS1” to “RS 5”). Specifically, for example, if the UE (e.g., the first and second apparatuses 102) is/are to use RS6 for determining QCL, then it is indicated by “00100000” in the MAC CE.

Accordingly, in the example scenario, based on the QCL-discovery message, there can be multiple modes of discovery/models of discovery, in accordance with an embodiment of the disclosure. A first example model/mode can be based on a general approach of, for example, querying (e.g., querying “Is someone Quasi-collocated with me?”). A second example model/mode can be based on a general approach of, for example, broadcasting (e.g., broadcasting “Yes I am nearby and in verified QCL”).

It is contemplated that, in one embodiment, establishing/determination of QCL relationship by manner of a QCL-discovery message can be performed multiple (e.g., several) times until certain confidence can be achieved. As an option, periodic re-checks can be performed for additional confidence, if necessary. It is further contemplated that establishing/determination of QCL relationship by manner of a QCL-discovery message can possibly be, for example, a 3GPP-compatible alternative, in accordance with an embodiment of the disclosure.

In the above manner, the present disclosure contemplates that sidelink communication within a vehicle (i.e., UE carried within a vehicle such as the aforementioned first and second apparatuses 102) can be possible, in accordance with an embodiment of the disclosure. In this regard, in-vehicle QCL can possibly be facilitated, in accordance with an embodiment of the disclosure. In-vehicle QCL can relate to an established/determined QCL relationship between the UE (e.g., in-vehicle UE such as the first and second apparatuses 102) carried by the vehicle.

Moreover, sidelink communication between within a vehicle and outside of the vehicle can be facilitated by manner of QCL-notification (e.g., a QCL-notification message), in accordance with an embodiment of the disclosure. A QCL-notification (e.g., which can be associated with the aforementioned in-vehicle QCL) can, for example, be communicated from the first apparatus 102 and/or the second apparatus 102. In one example, sidelink communication between vehicles (e.g., between the first and/or second apparatuses 102 carried by one vehicle and the third apparatus 102 carried by another vehicle) can be possible. In this regard, the QCL notification can be communicated from the first apparatus 102 and/or the second apparatus 102 to, for example, the third apparatus 102. In another example, sidelink communication between a vehicle and a non-vehicle (e.g., between the apparatus(es) 102 carried by a vehicle and a device 104 carried by, for example, a pedestrian) can be possible. In this regard, the QCL-notification can be communicated from the first apparatus 102 and/or the second apparatus 102 to, for example, the device(s) 104.

Appreciably, sidelink transmitter(s) and/or receiver(s) (i.e., outside of a vehicle) can be aware of the aforementioned in-vehicle QCL and such awareness can be useful (e.g., leverage such knowledge in a number of ways. For example, sidelink relaying can be useful. Sidelink relaying can be associated with a situation where broadcast/groupcast from in-vehicle QCL (e.g., from the first apparatus 102 or the second apparatus 102) to, for example, the device(s) 104.

Additionally, it is contemplated that transmission diversity can be facilitated, in accordance with an embodiment of the disclosure. For example, the first apparatus 102 and the second apparatus 102 can simply transmit, separately, the same set of information to, for example, other vehicles (e.g., the third apparatus 102) and/or pedestrian(s) (e.g., carrying the device(s) 104) using the same resources in the resource pool (i.e., they intentionally collide) so that the tandem would work as a distributed antenna to add diversity. The in-vehicle UE (e.g., the first and second apparatus 102) can agree to use the same antenna port for transmission, thereby achieving transmission diversity, which is especially useful for groupcast/broadcast. Such cooperative transmission can be triggered based on channel feedback (e.g., Reference Signal Received Power, RSRP, values) from receiver(s) (e.g., an external receiver which receives transmission from the first and/or the second apparatuses 102).

Furthermore, it is contemplated that synchronization can possibly be simplified and/or facilitated in a more efficient manner, in accordance with an embodiment of the disclosure. Synchronization can, for example, be via the communication network 106 (e.g., using GNSS) and/or directly/indirectly through another UE. The present disclosure contemplates the possibility that QCL can be utilized to simplify the synchronization procedure for all in-vehicle UE (e.g., the first and second apparatuses 102). Specifically, it is contemplated that possibly only one of the UE (e.g., the first apparatus 102) would need to perform the task of synchronization and the same synchronization parameter(s) can potentially be used for one or more other in-vehicle UE (e.g., the second apparatus 102).

Yet furthermore, it is contemplated that sidelink channel estimation can be facilitated, in accordance with an embodiment of the disclosure. Specifically, it is contemplated that density of DMRS (Demodulation reference signal) used for PSSCH (Physical Sidelink Control Channel) can be dynamically changed in time depending on channel coherence. In this regard, it is contemplated that the same density of DMRS can potentially be used for all in-vehicle UE (e.g., the first and second apparatuses 102).

The above-described advantageous aspect(s) of the system 100 of the present disclosure can also apply analogously (all) the aspect(s) of a below described apparatus 102 of the present disclosure. Likewise, all below described advantageous aspect(s) of the apparatus 102 of the disclosure can also apply analogously (all) the aspect(s) of above described system 100 of the disclosure.

The aforementioned apparatus(es) 102 will be discussed in further detail with reference to FIG. 2 hereinafter.

Referring to FIG. 2, an apparatus 102 is shown in further detail in the context of an example implementation 200, according to an embodiment of the disclosure.

In the example implementation 200, the apparatus 102 can correspond to an electronic module 200a which can be capable of performing one or more processing tasks in association with any one of QCL-discovery, QCL-determination and QCL-notification, or any combination thereof (i.e., QCL-discovery, QCL-determination and/or QCL-notification). The electronic module 200a can, in one example, correspond to a mobile device which can, for example, be carried into the vehicle by a user, in accordance with an embodiment of the disclosure. In another example, the electronic module 200a can correspond to an electronic device which can be installed/mounted in the vehicle, in accordance with an embodiment of the disclosure. In this regard, the electronic module 200a can be considered to be carried by the vehicle (e.g., either carried into the vehicle by a user or installed/mounted in the vehicle) and can, for example, be referred to as an in-vehicle UE (i.e., UE carried by the vehicle).

In one embodiment, the electronic module 200a can be capable of performing processing task(s) in association with QCL-discovery. In another embodiment, the electronic module 200a can be capable of performing processing task(s) in association with QCL-determination. In yet another embodiment, the electronic module 200a can be capable of performing processing task(s) in association with QCL-notification. In yet a further embodiment, the electronic module 200a can be capable of performing processing task(s) in association with QCL-discovery, QCL-determination and QCL-notification. In yet a further additional embodiment, the electronic module 200a can be capable of performing processing task(s) in association with at least one of QCL-discovery, QCL-determination and QCL-notification (i.e., any combination of QCL-discovery, QCL-determination and QCL-notification; QCL-discovery, QCL-determination and/or QCL-notification).

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the disclosure.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the disclosure. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the disclosure.

In one example, the first module 202 can correspond to a hardware-based receiver which can be configured to receive one or more input signals. The input signal(s) can, for example, include the aforementioned RSRP values.

The second module 204 can, for example, correspond to a hardware-based processor which can be configured to perform one or more processing tasks in association with any one of, or any combination of, the following:
QCL-discovery
QCL-determination
QCL-notification

The third module 206 can correspond to a hardware-based transmitter which can be configured to communicate one or more output signals from the electronic module 200a. The output signal(s) can, for example, include/correspond to/be indicative of the QCL-discovery and/or the QCL-notification. Moreover, the output signal(s) can, for example, be communicated from the electronic module 200a to the device(s) 104 (e.g., carried by a pedestrian) and/or another apparatus 102 (e.g., the third apparatus 102) carried by another vehicle.

The present disclosure contemplates the possibility that the first and second modules 202/204 can be an integrated software-hardware based module (e.g., an electronic part which can carry a software program/algorithm in association with receiving and processing functions/an electronic module programmed to perform the functions of receiving and processing). The present disclosure further contemplates the possibility that the first and third modules 202/206 can be an integrated software-hardware based module (e.g., an electronic part which can carry a software program/algorithm in association with receiving and transmitting functions/an electronic module programmed to perform the functions of receiving and transmitting). The present disclosure yet further contemplates the possibility that the first and third modules 202/206 can be an integrated hardware module (e.g., a hardware-based transceiver) capable of performing the functions of receiving and transmitting.

The foregoing example implementation 200 will be discussed based on a more specific example implementation, in accordance with an embodiment of the disclosure, hereinafter.

In the more specific example implementation, a scenario involving an apparatus 102 which is carried by a user and another apparatus 102 which is installed/mounted in a vehicle is contemplated. For the sake of additional clarity (e.g., ease of differentiating between an apparatus 102 which is carried by a user and another apparatus 102 which is installed/mounted in a vehicle), the apparatus 102 which is carried by a user can be referred to as “in-vehicle apparatus 102” in the context of this more specific example implementation. The another apparatus 102 which is installed/mounted in a vehicle can be referred to as “vehicle UE” in the context of this more specific example implementation.

Both the in-vehicle apparatus 102 and the vehicle UE can be carried by a vehicle. The in-vehicle apparatus 102 and the vehicle UE can be considered to be/correspond to UE carried by/in the vehicle (e.g., the first and second apparatuses 102), and can be referred to as in-vehicle UE. Specifically, the in-vehicle apparatus 102 and the vehicle UE can be referred to as “in-vehicle UE”.

Moreover, in this more specific example implementation, the first module 202 can correspond to a receiver (referrable to as a “receiver 202”), the second module 204 can correspond to a processor (referrable to as a “processor 204”) and the third module 206 can correspond to a transmitter (referrable to as a “transmitter 206”).

In this regard, in one embodiment, the in-vehicle apparatus 102 can include a processor 204 which can be configured to perform one or more processing tasks in association with any one of, or any combination of, the following:
QCL-discovery
QCL-determination
QCL-notification

The in-vehicle apparatus 102 can, in another embodiment, include one or both of a receiver 202 (e.g., to receive at least one input signal) and a transmitter 204 (e.g., to communicate at least one output signal).

In view of the foregoing, it is appreciable that the present disclosure generally contemplates an apparatus 102 (e.g., in-vehicle apparatus 102) which can be suitable for use for direct communication (e.g., sidelink-based communication) in association with one or more user equipment (e.g., vehicle user equipment (UE)) which can, for example, be proximal, in location, to the apparatus 102, in accordance with an embodiment of the disclosure. Specifically, the apparatus 102 can, for example, be suitable for use for sidelink communication in association with proximal UE (e.g., one or more UE in the proximity of the apparatus 102), in accordance with an embodiment of the disclosure.

The apparatus 102 and the UE (e.g., proximal UE) can, for example, be carried by/in a vehicle (e.g., both the apparatus 102 and the proximal UE can be carried by.in the same vehicle).

The apparatus 102 can, for example, include a processor 202 and a transmitter 204, in accordance with an embodiment of the disclosure. The processor 202 can be coupled to the transmitter 204.

The processor 202 can be configured to generate a Quasi Colocation (QCL)-discovery message and the transmitter 204 can be configured to communicate the QCL-discovery message. For example, the transmitter 204 can be configured to communicate the QCL-discovery message in a manner such that the QCL-discovery message can be received by the UE (i.e., proximal UE). Moreover, the apparatus 102 and the UE (i.e., proximal UE) can be capable of communicating (e.g., with each other) based on sidelink communication. It is contemplated that the QCL relationship between the apparatus 102 and the UE (i.e., proximal UE) can be determined based on the QCL-discovery message.

In one embodiment, the processor 202 can be configured to generate the QCL-discovery message based on a Proximity Services (ProSe) framework using vehicle QCL-specific information. Moreover, the QCL-discovery message can, for example, be associated with a sub-procedure of QCL-determination, in accordance with an embodiment of the disclosure. It is contemplated that QCL-determination can, for example, be based on dedicated sidelink resources indicated by a node initiating sidelink communication using either system information or Medium access control (MAC)-level signaling, in accordance with an embodiment of the disclosure. It is contemplated that the system information capable of being broadcasted on demand, in accordance with an embodiment of the disclosure.

In one embodiment, QCL determination can, for example, be via Medium Access Control (MAC) Control Elements (CE). The MAC CE can be associated with a plurality of parameters (RS), wherein usage of an RS is indicated through bit map by manner of using at least one octet, and wherein “1” indicates that an RS is being used and “0” indicates that an RS is not being used. For example, the MAC CE format can, for example, be indicated by “00100000”.

It is appreciable that in the above manner, that QCL (e.g., in-vehicle QCL) can possibly be facilitated, in accordance with an embodiment of the disclosure. As mentioned earlier, in-vehicle QCL can relate to an established/determined QCL relationship between the UE (e.g., the in-vehicle apparatus 102 and the vehicle UE) carried by the vehicle.

Moreover, it is appreciable that direct communication (e.g., sidelink communication) between within a vehicle and outside of the vehicle can possibly be facilitated by manner of QCL-notification (e.g., a QCL-notification message), in accordance with an embodiment of the disclosure. In this regard, for example, sidelink communication between a vehicle and another vehicle, and/or, for example, sidelink communication between a vehicle and a pedestrian etc. can be facilitated.

Additionally, it is appreciable that, sidelink channel estimation and/or transmission diversity can possibly be facilitated, in accordance with an embodiment of the disclosure.

The present disclosure further contemplates that synchronization can possibly be simplified and/or facilitated in a more efficient manner, in accordance with an embodiment of the disclosure.

The above-described advantageous aspect(s) of the apparatus 102 of the present disclosure can also apply analogously (all) the aspect(s) of a below described communication method of the present disclosure. Likewise, all below described advantageous aspect(s) of the data communication method of the disclosure can also apply analogously (all) the aspect(s) of above described apparatus 102 of the disclosure. It is to be appreciated that these remarks apply analogously to the earlier discussed system 100 of the present disclosure.

Referring to FIG. 3, a communication method in association with the system 100 is shown, according to an embodiment of the disclosure. The communication method 300 can, for example, be suitable for facilitating communication (e.g., direct communication such as sidelink communication) in association with UE (e.g., in-vehicle UE), in accordance with an embodiment of the disclosure.

The communication method 300 can include any one of a discovery step 302, a determination step 304, a notification step 306 and an output step 308, or any combination thereof, in accordance with an embodiment of the disclosure.

In one embodiment, the communication method 300 can include the discovery step 302. In another embodiment, the communication method 300 can include the discovery step 302 and the determination step 304. In another embodiment, the communication method 300 can include the discovery step 302, the determination step 304 and the notification step 306. In yet another embodiment, the communication method 300 can include the discovery step 302 and any combination of the determination step 304, the notification step 306 and the output step 308. In yet a further embodiment, the communication method 300 can include the discovery step 302, the determination step 304, the notification step 306 and the output step 308. In yet a further additional embodiment, the communication method 300 can include any combination of the discovery step 302, the determination step 304, the notification step 306 and the output step 308 (i.e., the discovery step 302, the determination step 304, the notification step 306 and/or the output step 308).

With regard to the discovery step 302, a processing task/a step of QCL-discovery can be performed. For example, QCL-discovery can be by manner of generating a QCL-discovery message. The processing task/the step of QCL-discovery can, for example, be performed by the apparatus 102 (e.g., via the second module 204/the processor 204), in accordance with an embodiment of the disclosure.

With regard to the determination step 304, a processing task/a step of QCL-determination can be performed. For example, QCL-determination can, as mentioned earlier, be a sub-procedure associated with the QCL-discovery. The processing task/the step of QCL-determination can, for example, be performed by the apparatus 102 (e.g., via the second module 204/the processor 204), in accordance with an embodiment of the disclosure.

With regard to the notification step 306, a processing task/a step of QCL-notification can be performed. For example, QCL-notification can be by manner of generating a QCL-notification message. The processing task/the step of QCL-notification can, for example, be performed by the apparatus 102 (e.g., via the second module 204/the processor 204), in accordance with an embodiment of the disclosure.

With regard to the output step 308, at least one output signal can be communicated. The output signal(s) can, for example, include/correspond to/be indicative of one or both of the QCL-discovery message and the QCL-notification message, in accordance with an embodiment of the disclosure. The output signal(s) can, for example, be communicated from the apparatus 102 (e.g., via the third module 206/the transmitter 206), in accordance with an embodiment of the disclosure.

In view of the foregoing, it is appreciable that the present disclosure generally contemplates a communication method 300 which can be suitable for use for communication (e.g., direct communication such as sidelink communication) between an apparatus 102 (e.g., in-vehicle apparatus 102) and a user equipment (UE) (e.g., vehicle UE) which can, for example, be proximal, in location, to the apparatus 102, in accordance with an embodiment of the disclosure. Specifically, the apparatus 102 can be suitable for use for, for example, sidelink communication in association with proximal UE (e.g., one or more UE in the proximity of the apparatus 102), in accordance with an embodiment of the disclosure.

The communication method 300 can include a discovery step 302 wherein Quasi-Colocation (QCL) relationship between the apparatus 102 and the UE (i.e., proximal UE) can be determined. It is contemplated that the QCL relationship can be determined by manner of, for example, a QCL-discovery message. The QCL-discovery message can, for example, be generated by the processor 202 (e.g., of the apparatus 102, in accordance with an embodiment of the disclosure and/or of the UE, in accordance with an embodiment of the disclosure). The QCL-discovery message can, for example, be communicated between the apparatus 102 and the UE (i.e., proximal UE), in accordance with an embodiment of the disclosure. In one embodiment, communication between the apparatus 102 and the UE can be based on sidelink communication.

The data communication method 300 can further include at least one of (i.e., any one of or any combination of the following):
a determination step 304 wherein a processing task of QCL-determination is performed. The QCL-determination can, for example, be a sub-procedure associated with QCL-discovery.
a notification step 306 wherein a QCL-notification message can be generated. The QCL-notification message can, for example, be communicated from the apparatus 102, in accordance with an embodiment of the disclosure.
an output step 308 wherein at least one output signal can be communicated from, for example, the apparatus 102. The output signal(s) can, for example, include one or both of the QCL-discovery message and the QCL-notification message (i.e., at least one of the QCL-discovery message and the QCL-notification message; the QCL-discovery message and/or the QCL-notification message), in accordance with an embodiment of the disclosure.

It is appreciable that in the above manner, that QCL (e.g., in-vehicle QCL) can possibly be facilitated, in accordance with an embodiment of the disclosure. As mentioned earlier, in-vehicle QCL can relate to an established/determined QCL relationship between the UE (e.g., the in-vehicle apparatus 102 and the vehicle UE) carried by the vehicle.

Moreover, it is appreciable that direct communication (e.g., sidelink communication) between within a vehicle and outside of the vehicle can possibly be facilitated by manner of QCL-notification (e.g., a QCL-notification message), in accordance with an embodiment of the disclosure. In this regard, for example, sidelink communication between a vehicle and another vehicle, and/or, for example, sidelink communication between a vehicle and a pedestrian etc. can be facilitated.

Additionally, it is appreciable that, sidelink channel estimation and/or transmission diversity can possibly be facilitated, in accordance with an embodiment of the disclosure.

The present disclosure further contemplates that synchronization can possibly be simplified and/or facilitated in a more efficient manner, in accordance with an embodiment of the disclosure.

The present disclosure further contemplates a computer program (not shown) which can include instructions which, when the program is executed by a computer (not shown), cause the computer to carry out the discovery step 302, the determination step 304, the notification step 306 and/or the output step 308 as discussed with reference to the communication method 300.

The present disclosure yet further contemplates a computer readable storage medium (not shown) having data stored therein representing software executable by a computer (not shown), the software including instructions, when executed by the computer, to carry out the discovery step 302, the determination step 304, the notification step 306 and/or the output step 308 as discussed with reference to the communication method 300.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, it is contemplated that the foregoing discussion can be relevant for infrastructure based and/or infrastructure-based vehicular type communication(s), in accordance with an embodiment of the disclosure.

In another example, the foregoing discussion can be relevant for multi-Radio Access Technology (multi-RAT), in accordance with an embodiment of the disclosure. Moreover, earlier mentioned, an example of direct communication can be sidelink communication, it is to be appreciated that other examples are also useful. For example, Radio Access Technologies (RATs), e.g., Bluetooth or IEEE 802.11 (WiFi) can be useful examples.

In yet another example, the earlier mentioned QCL-discovery, QCL-determination and/or QCL-notification had been discussed in a specific example implementation in the context of an in-vehicle apparatus 102, it is appreciable that the discussion concerning QCL-discovery, QCL-determination and/or QCL-notification can be analogously applicable to a vehicle UE. In one example, processing tasks associated with QCL-discovery, QCL-determination and/or QCL-notification can be performed by a vehicle UE. In another example, processing tasks associated QCL-discovery, QCL-determination and/or QCL-notification can be performed by both the in-vehicle apparatus 102 and the vehicle UE. In yet another example, some of the processing tasks associated with QCL-discovery, QCL-determination and/or QCL-notification can be performed by the in-vehicle apparatus 102 and some of the processing tasks associated with QCL-discovery, QCL-determination and/or QCL-notification can be performed by the vehicle UE.

In yet another additional example, it was earlier mentioned (in the more specific example implementation), that for the sake of additional clarity (e.g., ease of differentiating between an apparatus 102 which is carried by a user and another apparatus 102 which is installed/mounted in a vehicle), the apparatus 102 which is carried by a user can be referred to as “in-vehicle apparatus 102” in the context of this more specific example implementation. The another apparatus 102 which is installed/mounted in a vehicle can be referred to as “vehicle UE” in the context of the more specific example implementation. It is to be appreciated that the converse can analogously be possible in that the apparatus 102 which is carried by a user can be referred to as “vehicle UE” and the another apparatus 102 which is installed/mounted in a vehicle can be referred to as “in-vehicle apparatus 102”, depending on the context (e.g., in another more specific example implementation) as appropriate.

In this regard “in-vehicle apparatus 102” can refer to an apparatus 102 carried into a vehicle or an apparatus 102 installed/mounted in the vehicle, as appropriate. Similarly, “vehicle UE” can refer to an apparatus 102 carried into a vehicle or an apparatus 102 installed/mounted in the vehicle, as appropriate. Generally, it should be appreciated that the “in-vehicle apparatus 102” and the “vehicle UE” can, for example, refer to different/distinct apparatuses 102, in accordance with an embodiment of the disclosure. The “in-vehicle apparatus 102” and the “vehicle UE” can be analogous with regard to hardware and/or software function and/or structure (e.g., as discussed with reference to FIG. 2), in accordance with an embodiment of the disclosure. For example, the “vehicle UE” can analogously include the first module 202 (e.g., a receiver), the second module 204 (e.g., a processor) and/or the third module 206 (e.g., a transmitter), as discussed with reference to FIG. 2, in accordance with an embodiment of the disclosure.

In yet a further additional example, the system 100 had earlier been discussed based on an example context of sidelink communication in association with in-vehicle UE, in accordance with an embodiment of the disclosure. It can be appreciated the foregoing discussion can analogously apply in a non-vehicle context (e.g., in a room within a building and/or between users such as pedestrians who can in within the vicinity). For example, the apparatus 102 can correspond to a mobile device carried by a user and the device 104 can correspond to another mobile device carried by another user.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An apparatus suitable for use for direct communication in association with at least one user equipment (UE) proximal to the apparatus, the apparatus comprising:
a processor configured to generate a Quasi Colocation (QCL)-discovery message; and
a transmitter coupled to the processor, the transmitter configured to communicate the QCL-discovery message,
wherein the QCL-discovery message is receivable by the UE,
wherein the apparatus and the UE are capable of communicating based on direct communication, and
wherein the QCL relationship between the apparatus and the UE is determinable based on the QCL-discovery message.

2. The apparatus according to claim 1, the processor is configurable to generate the QCL-discovery message based on a Proximity Services (ProSe) framework using vehicle QCL-specific information.

3. The apparatus according to claim 1, wherein direct communication corresponds to sidelink communication.

4. The apparatus according to claim 1, the QCL-discovery message being associable with a sub-procedure of QCL-determination.

5. The apparatus according to claim 1, QCL-determination being based on dedicated sidelink resources indicated by a node initiating sidelink communication.

6. The apparatus according to claim 1, the node initiating sidelink communication using one of system information and Medium access control (MAC)-level signaling.

7. The apparatus according to claim 1, the system information capable of being broadcasted on demand.

8. The apparatus according to claim 1, QCL determination being via Medium Access Control Control Elements (CE) associable with a plurality of parameters (RS),
wherein usage of an RS is indicated through bit map by manner of using at least one octet, and
wherein “1” indicates that the RS is being used and “0” indicates that the RS is not being used.

9. The apparatus according to claim 1 further configurable to generate and communicate a QCL-notification message.

10. A communication method suitable for use for direct communication between an apparatus and at least one equipment (UE) proximal to the apparatus, the communication method comprising:
a discovery step wherein Quasi-Colocation (QCL) relationship between the apparatus and the UE is determinable,
wherein the QCL relationship is determinable by manner of a QCL-discovery message, generatable by a processor, communicable between the apparatus and the UE, and
wherein communication between the apparatus and the UE is based on direct communication; and
wherein the apparatus comprises;
a processor configured to generate a Quasi Colocation (OCL)-discovery message; and
a transmitter coupled to the processor the transmitter configured to communicate the QCL-discovery message,
wherein the QCL-discovery message is receivable by the UE,
wherein the apparatus and the UE are capable of communicating based on direct communication, and
wherein the OCL relationship between the apparatus and the UE is determinable based on the QCL-discovery message.

11. The data communication method of claim 10, further comprising at least one of:
a determination step wherein a processing task of QCL-determination is performed, QCL-determination being a sub-procedure associated with QCL-discovery;
a notification step wherein a QCL-notification message is generatable and communicable from the apparatus; and
an output step wherein at least one output signal is communicable from the apparatus, the at least one output signal comprising at least one of the QCL-discovery message and the QCL-notification message.

12. The data communication method-(300) of claim 10, direct communication corresponding to sidelink communication.

13. (canceled)

14. (canceled)
